(19) United States
(12) Patent Application Publication
(10) Pub. No.: US 2013/0037731 A1
(43) Pub. Date: Feb. 14, 2013

(54) REFRIGERATOR COMPRISING AN ELECTRIC VALVE

(71) Applicant: Athanasios Athanasiou, Giengen (GR)

(72) Inventor: Athanasios Athanasiou, Giengen (GR)

(73) Assignee: BSH BOSCH UND SIEMENS HAUSGERATE GMBH, Munich (DE)

(21) Appl. No.: 13/642,559

(22) PCT Filed: Apr. 28, 2011
(86) PCT No.: PCT/EP11/56751

§ 371 Date: Oct. 22, 2012

(30) Foreign Application Priority Data
May 6, 2010 (DE) 10 2010 028 703.2

(51) Int. Cl. F16K 31/02

(52) U.S. Cl. 251/129.01

(57) ABSTRACT

A refrigerator includes an electric valve that can be transferred into a closed state in response to a closing signal. In order to increase the tightness of the electric valve, the refrigerator includes a valve driver unit which is designed to subject the electric valve in the closed state to a sequence of closing signals.

The present invention relates to a refrigerator comprising an electric valve, in particular comprising an electric water valve.

In modern refrigerators electric valves are often used which, for example, are used to control the supply of water to a refrigerator or to an ice maker of a refrigerator. Known electric valves usually comprise electrically excitable coils and valve pistons which can be moved back and forth in response to a field generated by the coil. To generate the field an excitation signal is usually applied to the coil, whereupon the valve piston, for example, is moved in the direction of a valve seat and the electric valve closes. However, it may transpire that the water moves the valve piston, for example, as a result of vibrations, which may result in leakage of the valve when it is closed.

It is therefore the object of this invention to create an efficient design to increase the tightness of a closed electric valve of a refrigerator. This object is achieved by the features of the independent claims. Advantageous developments are the subject of the dependent claims.

A refrigerator is understood to mean in particular a domestic refrigerator, in other words a refrigerator which is used for household operation in households or possibly also in the catering sector, and in particular to store food and/or drinks at particular temperatures in quantities usual for a household, such as for example a refrigerator, freezer or a refrigerator-freezer combination. In particular, the refrigerator has a water connection, for example, for an ice maker or for a water dispenser.

The present invention is based on the understanding that the tightness of a closed valve can be increased, for example, by constant adjustment of a valve piston of the electric valve against a valve seat in a closed position, in which the valve is closed. This can be achieved in an electric valve, for example, by the electric valve being subject in the closed state to a sequence of closing signals in response to which, for example, the valve piston is constantly adjusted in the direction of the valve seat.

In accordance with one aspect, the invention relates to a refrigerator comprising an electric valve that can be transferred into a closed state in response to a closing signal. The refrigerator comprises a valve driver unit, which is designed to subject the electric valve in the closed state to a sequence of closing signals in order to increase the tightness of the electric valve. The term closed state is understood to mean the state of the electric valve in which a fluid flow, for example a water flow, is prevented by the electric valve. When the valve is acted on by the sequence of closing signals, these can for example be applied to a coil of the electric valve in order to generate a periodic field, for example as a consequence of excitation signals, that periodically adjusts a valve piston against a valve seat of the electric valve. The valve driver unit may in addition be designed to transfer the valve by means of an opening signal into an opened state in which a fluid flow is enabled by the electric valve.

According to one embodiment the electric valve comprises a valve piston to seal a valve seat of the electric valve, wherein in the closed state the valve piston can be adjusted in the direction of the valve seat in response to the sequence of closing signals. The valve piston is constantly pressed against the valve seat in the process, for example, as a result of which increased tightness is achieved in the closed state of the electric valve.

According to one embodiment the sequence of closing signals is a pulse sequence, for example, a rectangular pulse sequence, which may be periodic. The period length is preferably shorter than the duration of the closed state so that the electric valve can be constantly closed in this state.

According to one embodiment the sequence of closing signals is a periodic direct voltage signal, for example, a positive or a negative periodic direct voltage signal with signal sections of higher amplitude, and with signal sections of lower amplitude. The periodic direct voltage signal can, for example, be a periodic rectangular sequence or a rectified sinusoidal signal or a rectified cosine signal.

According to one embodiment the sequence of closing signals is a current sequence or a voltage sequence.

According to one embodiment the valve driver unit comprises a transistor circuit or a capacitor or a clock signal generator to generate the sequence of closing signals. Thus, for example, the transistor circuit may have a capacitor which is constantly charged and discharged, as a result of which the sequence of closing signals can be realized.

According to one embodiment the valve driver unit is designed to transfer the electric valve by means of the closing signal or by means of an additional closing signal into the closed state, and for example, then to subject the electric valve to the sequence of closing signals. The additional closing signal can be distinguished from the closing signal and for example be provided to first transfer the valve into the closed state, while the closing signal can be used to adjust the closing state.

According to one embodiment the electric valve comprises a coil to which the sequence of closing signals to drive a valve piston can be applied, for example, by means of the valve driver unit.

According to one embodiment the electric valve is an electric water valve.

According to an additional aspect, the invention relates to a method for increasing the tightness of an electric valve of a refrigerator with the transfer of the electric valve into a closed state, for example, by means of a closing signal, and subjecting the electric valve in the closed state to a sequence of closing signals to increase the tightness of the electric valve in the closed state.

Additional exemplary embodiments of the invention are explained with reference to the attached drawings which show:

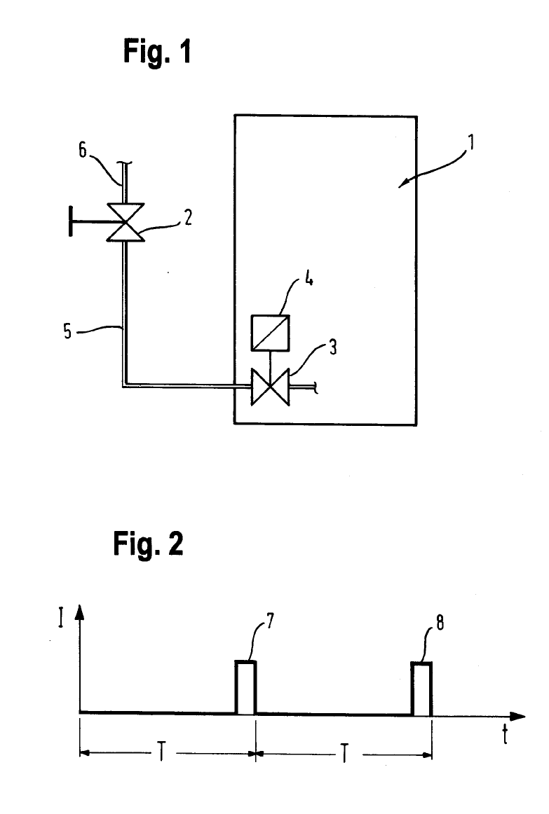

FIG. 1 a refrigerator; and

FIG. 2 a sequence of closing signals.

FIG. 1 shows a refrigerator 1, which for example can be connected to a water supply valve 2, for example to a faucet, by means of an electric water valve 3 of the refrigerator 1. The water supply valve 2 may be a component of the refrigerator. According to one embodiment the water supply valve 2 may be an external valve, for example, a faucet.

In addition, the refrigerator 1 comprises a valve driver unit 4, which is connected to the electric valve 3, for example, to an electric water valve. The electric valve 3 is connected to the water supply valve 2 by means of a water pipe 5. The water supply valve 2 can for example be connected to a water supply line 6.

To add water to the refrigerator 1, the valve driver unit 4 can transfer the electric valve 3 into an opened state, for example, with the aid of an opening signal. To interrupt the water supply, the valve driver unit 4 can, however, subject the electric valve 3 to a closing signal by means of which the electric valve 3 is closed, i.e. is transferred into a closed state. For this purpose the electric valve can for example have a coil and a valve piston moveable therein which, in response to the field generated by the closing signal is pressed against a valve seat by means of the coil. After the transfer of the electric valve 3 into the closed state, i.e. after closing the electric valve 3, this is constantly adjusted, for example by constant pulses, which can be generated by the valve driver unit 4, i.e. transferred into the closed state or kept in this state. As a result the valve pistons can be constantly pressed against the valve seat to eliminate any leaks on account of vibrations generated by water.

The valve driver unit 4 can, for example, generate a current signal sequence or a voltage signal sequence as the sequence of closing signals, as shown in FIG. 2.

FIG. 2 shows an exemplary sequence of closing signals 7 and 8 which for example can be rectangular pulses. The closing signals 7 and 8 are for example, periodically shown with a period T, as in FIG. 2. The closing signals shown in FIG. 2 can be, for example, current pulses with amplitude I. Such pulsed control of the electric valve causes a periodic closing of the electric valve in the closed state, as a result of which the tightness of the valve 3 in the refrigerator 1 can be increased. The pulses may be rectangular. However, they may for example be low-pass or band-pass or high-pass filtered. For this purpose the valve driver unit can have a low-pass filter or a band-pass filter or a high-pass filter. In addition, the pulses may have sinusoidal or cosine-shaped flanks.

### LIST OF REFERENCE CHARACTERS

1 Refrigerator
2 Water supply valve
3 Electric valve
4 Valve driver unit
5 Water pipe
6 Water supply line
7, 8 Closing signal
T Period
I Amplitude

1-10. (canceled)

11. A refrigerator, comprising:
an electric valve transferable into a closed state in response to a closing signal; and
a valve driver unit configured to subject the electric valve in the closed state to a sequence of closing signals in order to increase a tightness of the electric valve.

12. The refrigerator of claim 11, wherein the electric valve has a valve piston in which a valve seat is sealed and which is adjustable in the closed state in a direction of the valve seat in response to the sequence of closing signals.

13. The refrigerator of claim 11, wherein the sequence of closing signals is a pulse sequence.

14. The refrigerator of claim 11, wherein the sequence of closing signals is a rectangular pulse sequence.

15. The refrigerator of claim 11, wherein the sequence of closing signals is a periodic direct voltage signal.

16. The refrigerator of claim 11, wherein the sequence of closing signals is a current sequence or a voltage sequence.

17. The refrigerator of claim 11, wherein the valve driver unit has a member selected from the group consisting of transistor circuit, capacitor, and a clock signal generator, to generate the sequence of closing signals.

18. The refrigerator of claim 11, wherein the valve driver unit is configured to transfer the electric valve into the closed state in response to the closing signal or in response to an additional closing signal.

19. The refrigerator of claim 11, wherein the electric valve has a coil and a valve piston movable in response to a field generated by the coil, said sequence of closing signals being applied to the coil to drive the valve piston.

20. The refrigerator of claim 11, wherein the electric valve is an electric water valve.

21. A method for increasing a tightness of an electric valve of a refrigerator, comprising:
transferring the electric valve into a closed state; and
subjecting the electric valve in the closed state to a sequence of closing signals to increase the tightness of the electric valve in the closed state.
